(19) United States
(12) Patent Application Publication
(10) Pub. No.: US 2003/0153203 A1
(43) Pub. Date: Aug. 14, 2003

(54) Convenience outlet mountable to a printed circuit board

(76) Inventor: Kimberly Ann Ketelsleger, Mechanicsburg, PA (US)

Correspondence Address: Tyco Electronics Corporation, MS R20/2B, 307 Constitution Drive, Menlo Park, CA, 94025, US

(21) Appl. No.: 10/074,371

(22) Filed: Feb. 12, 2002

(51) Int. Cl. H01R 12/00

(52) U.S. Cl. 439/82

(57) ABSTRACT

A convenience outlet is provided for mounting on a printed circuit board (PCB). The convenience outlet includes a connector housing having an outlet face configured to be mated with an electrical plug, a contact chamber having a contact secured therein, and an open end configured to abut against, and be mounted on, a PCB. The contact includes a beam and a contact blade. The beam is configured to electrically engage an electrical plug and the contact blade is configured to be inserted through a circular via in a PCB. Optionally, the contact may also have a stopping blade adjacent to the contact blade configured to abut against a surface of the PCB when the contact blade is fully inserted into the via. Optionally, the PCB can have multiple vias, and the outlet can have multiple contacts.

### BACKGROUND OF THE INVENTION

Certain embodiments of the present invention generally relate to electrical contacts and to connector housings for electrical contacts, and more particularly, to electrical convenience outlets mounted onto printed circuit boards (PCBs).

Convenience outlets have been proposed in the past to be mounted on a printed circuit board (PCB). The convenience outlets are configured to be quickly and easily installed onto PCBs. PCBs are typically formed from one or more layers of non-conductive material, such as plastic. The layers include conductive traces therein or thereon that carry power or data signals. Certain traces electrically join circular “through holes” that are formed through the PCB. The through holes are also referred to as “vias.” Each through hole, or via, includes a passage cut through the non-conductive layers of the PCB. The passage securely receives a conductive tubular-shaped liner that contacts one or more traces. Vias are used to interconnect traces that are located on opposite sides or within different layers of the PCB. Vias are also used to connect electrical components to the PCB. For example, a pattern of vias may be formed to correspond to the pin pattern on a processor, memory chip, a socket and the like. The vias include circular passages therethrough. These passages are circular in shape to correspond to the circular cross-section of pins on the mating component.

Convenience outlets have been configured to be mountable in the circular passages through the vias. A convenience outlet enables a connection to be made between the PCB and a male plug, such as an electrical cord. The convenience outlet may include a female receptacle on one side having a contact pattern similar to a wall receptacle. The convenience outlet also includes a set of pins arranged in a pin pattern aligning with a corresponding set of vias in the PCB. The pins on the convenience outlet have the same shape as pins on other components and sockets that are mounted on the PCB. The individual pins are circularly shaped and arranged to align with and fit in the vias. The pins are secured to the vias frictionally or through solder. Each pin is inserted into a separate via.

However, convenience outlets are expensive to manufacture due, in part, to the circular shape of the pins. Additionally, convenience outlets offer a limited power carrying capability as they exhibit undesirably high resistance and a less than ideal connection with the PCB. The connection between each pin and PCB may be enhanced with solder. However, the solder rests on top of the PCB and does not enter the vias in the PCB. Hence, the connection between the pins and PCB is through surface contact along the pins and vias and through solder (if present) at the top of the vias surrounding a small portion of each pin.

A need remains for an improved PCB mount convenience outlet.

### BRIEF SUMMARY OF THE INVENTION

An embodiment of the present invention provides a convenience outlet for mounting on a printed circuit board. The convenience outlet includes a connector housing and a contact. The housing includes an outlet face configured to be mated with an electrical plug, a contact chamber having the contact secured therein, and an open end configured to abut against, and be mounted on, a printed circuit board (PCB). The contact includes a beam and a contact blade. The beam is configured to electrically engage an electrical plug, and the contact blade is configured to be inserted through a circular via in the PCB. Optionally, the contact may have two or more beams extending adjacent to each other. The contact blade has a width that is substantially greater than a thickness of the contact blade. The contact blade also has a thickness that is substantially smaller than a diameter of the via and a width slightly less than the diameter of the via. The contact blade includes two opposed planar surfaces.

The contact blade may contain a chamfered outer end and may be stamped from a singe piece of material, in order that the contact blade and the beam are integrally formed with one another.

An advantage of certain embodiments of the present invention is that the convenience outlet can be manufactured cheaply since the contact can be stamped from a single piece of material.

A second advantage of certain embodiments of the present invention is that the contact provides the capability of carrying high power. The sufficient power carrying capability of the contact is enhanced, in part, because the contact blade and the beam are integrally formed with one another. The contact blade configuration enables solder to enter the via and provide a superior connection along the length of the contact blade with the via.

These and other features and embodiments of the present invention are discussed or apparent in the following detailed description of certain embodiments of the present invention.

### BRIEF DESCRIPTION OF SEVERAL VIEWS OF THE DRAWINGS

FIG. 1 illustrates a top front perspective view of a convenience outlet connector housing formed in accordance with an embodiment of the present invention.

FIG. 2 illustrates a bottom rear perspective view of the convenience outlet connector housing of FIG. 1.

FIG. 3 illustrates a bottom front perspective view of an active contact formed in accordance with an embodiment of the present invention.

FIG. 4 illustrates a top rear perspective view of an active contact formed in accordance with an embodiment of the present invention.

FIG. 5 illustrates a bottom front perspective view of a neutral contact formed in accordance with an embodiment of the present invention.

FIG. 6 illustrates a top plan view of a neutral contact formed in accordance with an embodiment of the present invention.

FIG. 7 illustrates a bottom front perspective view of a ground contact formed in accordance with an embodiment of the present invention.

FIG. 8 illustrates a top rear perspective view of a ground contact formed in accordance with an embodiment of the present invention.

FIG. 9 illustrates bottom rear perspective view of a connector housing with installed contacts formed in accordance with an embodiment of the present invention.

FIG. 10 illustrates top front perspective view of a printed circuit board formed in accordance with an embodiment of the present invention.

FIG. 11 illustrates a bottom perspective view of a connector housing with installed contacts mounted on a printed circuit board formed in accordance with an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentality shown in the attached drawings.

### DETAILED DESCRIPTION OF THE INVENTION

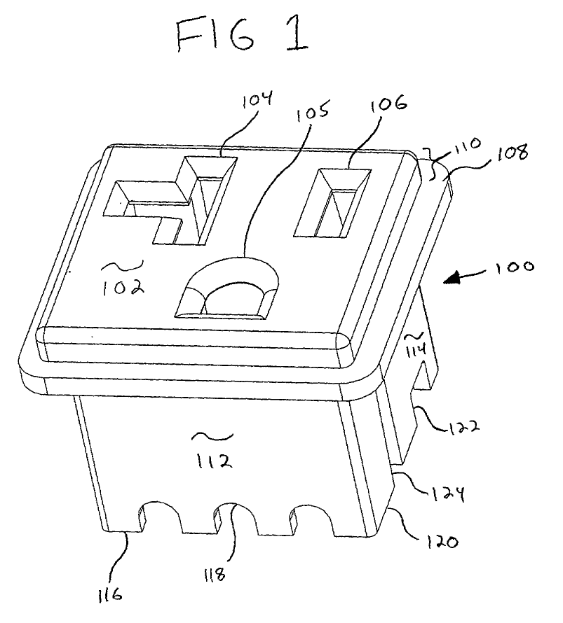

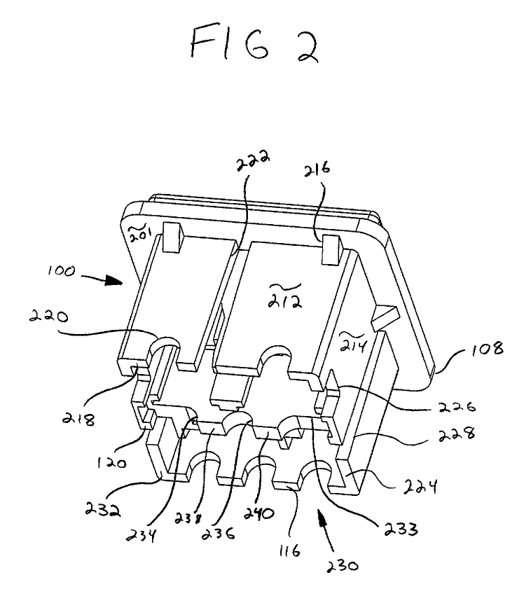

FIG. 1 illustrates a convenience outlet connector housing 100 formed in accordance with an embodiment of the present invention. The connector housing 100 includes an outlet face 102 configured to receive a mating electrical plug (not shown). The outlet face 102 includes neutral, ground and active slots 104-106 for receiving respective neutral, ground and active blades of an electrical plug. The connector housing 100 includes a ledge 108 that is located a step 110 down from the outlet face 102 and is aligned parallel to the outlet face 102. The ledge 108 is configured for securing the connector housing 100 within a larger structure, but is not necessarily used in all applications. The connector housing 100 includes sidewalls 112, 114, 212, 214 (FIGS. 1 & 2). Sidewall 112 includes a bottom edge 116 that may include heat dissipation notches 118 cut or formed therein. Sidewall 114 includes a bottom edge 120 that may include a heat dissipation notch 122 cut or formed therein. The sidewall 114 may also include a heat dissipation slit 124 cut or formed therein. The heat dissipation notch 122 extends vertically from the bottom edge 120 by a short distance, while the heat dissipation slit 124 extends vertically upward from the bottom edge 120 to an underside 201 (FIG. 2) of the ledge 108.

FIG. 2 illustrates a rear view of the connector housing 100. The sidewalls 112, 114, 212, 214 may include gussets 216 for supporting the ledge 108. The sidewall 212 includes a bottom edge 218. The bottom edge 218 may include heat dissipation notches 220. The sidewall 212 may include a heat dissipation slit 222, extending vertically from the bottom edge 218 of the sidewall 212 to the underside 201 of the ledge 108. The sidewall 214 includes a bottom edge 224 that may include a heat dissipation notch 226. The sidewall 214 may include a heat dissipation slit 228, extending vertically from the bottom edge 224 of the sidewall 214 to the underside 201 of the ledge 108. Optionally, different configurations, combinations and numbers of heat dissipation slits and heat dissipation notches may be used.

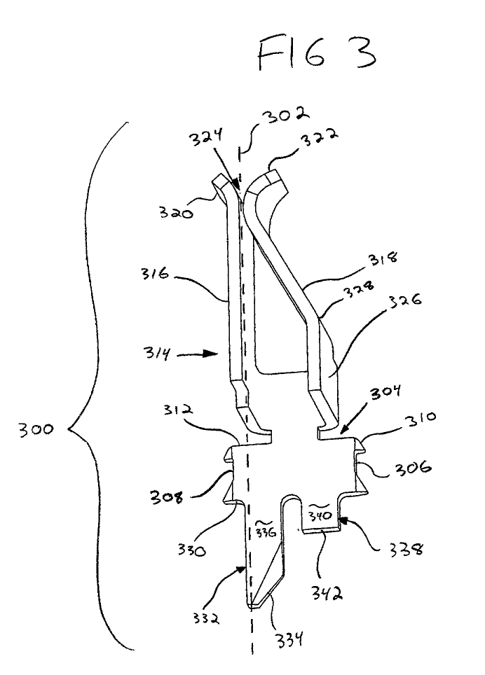

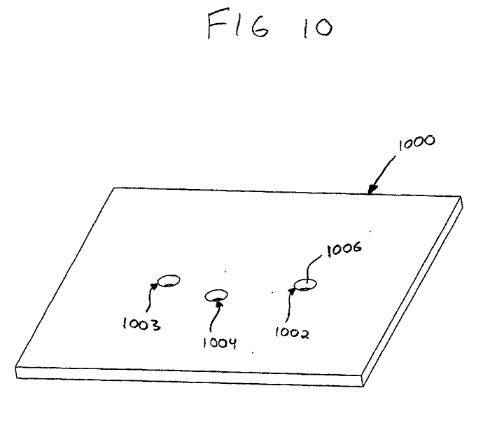

The sidewalls 112, 114, 212, 214 define a contact chamber 230. The contact chamber 230 includes an open end 232 of rectangular shape that is defined by the bottom edges 116, 120, 218, 224 of the sidewalls 112, 114, 212, 214, respectively. While FIG. 2 illustrates the open end 232 to be located on the bottom of the connector housing 100 and opposite to the outlet face 102, optionally the open end 232 may be formed in one the sidewalls 112, 114, 212, 214 to form a right-angle convenience outlet. The open end 232 is configured to receive, and the contact chamber is configured to retain, contacts 300, 500, 700 (FIGS. 3, 5, and 7). The open end 232 firmly engages a surface of a PCB 1000 (FIG. 10).

The connector housing 100 includes an inner wall 233 having stabilizing projections 234, 236. The stabilizing projections 234, 236 include bottom surfaces 238, 240 for stabilizing the connector housing 100 on the PCB 1000 (FIG. 10).

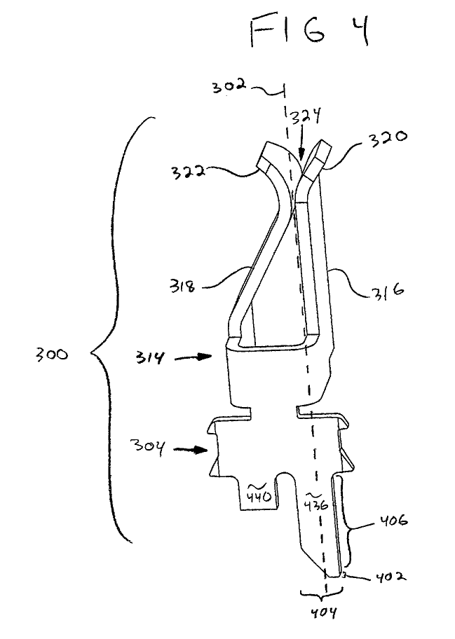

FIGS. 3 and 4 illustrate front and rear views of an active contact 300 formed in accordance with an embodiment of the present invention. The active contact 300 extends along a longitudinal axis 302 and includes a rectangular-shaped body section 304. The body section 304 includes two side edges 306, 308. Each side edge 306, 308 may include triangular retention bulges 310, extending outward from the body section 304. The retention bulges 310 retain the active contact 300 in the connector housing 100 when installed. The body section 304 includes an upper edge 312 that is formed with a blade-receiving section 314, extending upward from the body section 304. The blade-receiving section 314 includes a pair of beams 316 and 318, extending upward in a direction parallel to the longitudinal axis 302. Outer ends 320 and 322 of the beams 316 and 318 bend outward away from one another. The outer ends 320 and 322 may be separated by a gap 324. The beam 318 includes a base portion 326 spaced apart from the beam 316 and bent at a corner 328 inward toward the beam 316. The beam 318 extends upward at an angle toward the beam 316. The beams 316 and 318 are configured to frictionally receive a blade contact on an electrical plug mated with the connector housing 100.

The body section 304 includes a bottom edge 330 that is formed with a contact blade 332, extending downward along the longitudinal axis 302. The contact blade 332 is of a generally rectangular shape and has a chamfered outer end 334. The contact blade 332 includes two planar surfaces 336, 436 (FIGS. 3 & 4) that are parallel to one another. The contact blade 332 has a thickness 402, a width 404, and a length 406. The thickness 402 is substantially less than the width 404.

The contact may also include a stopping blade 338 extending from the bottom edge 330 of the body section 304. The stopping blade 338 is of the same general width and thickness as the contact blade 332, but is shorter in length. The stopping blade 338 includes two planar surfaces 340, 440 (FIGS. 3 & 4) that are parallel to one another and a flat bottom surface 342. The contact blade 332 is configured to be inserted into a via in the PCB 1000, until the stopping blade 338 abuts against a surface of the PCB 1000.

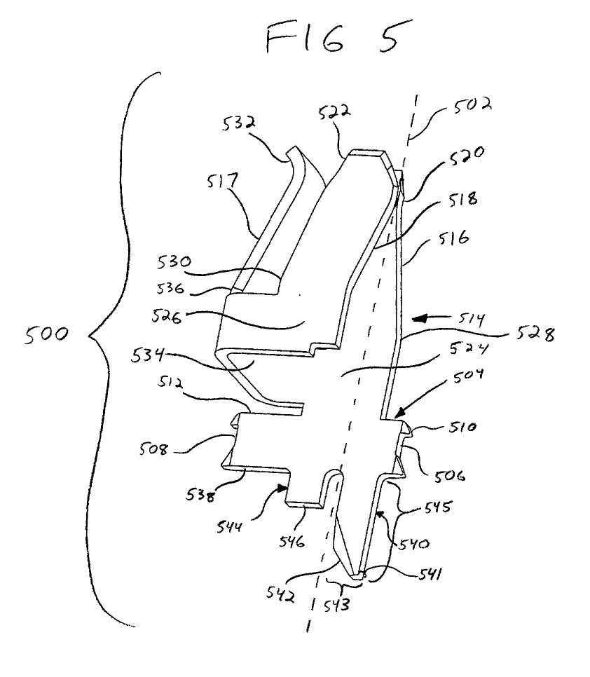

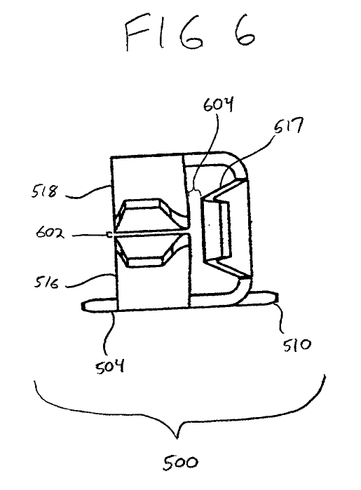

FIGS. 5 and 6 illustrate a neutral contact 500. The neutral contact 500 extends along a longitudinal axis 502 and includes a rectangular-shaped body section 504. The body section 504 includes two side edges 506, 508. Each side edge 506, 508 may include triangular retention bulges 510, extending outward from the body section 504. The retention bulges 510 retain the neutral contact 500 in the connector housing 100 when installed. The body section 504 includes an upper edge 512 that is formed with a blade-receiving section 514, extending upward from the body section 504. The blade-receiving section 514 includes beams 516-518, extending upward in a direction parallel to the longitudinal axis 502 and a direction perpendicular to the upper edge 512 of the body section 504.

Outer ends 520 and 522 of the beams 516 and 518 bend away from one another. The outer ends 520 and 522 may be separated by a gap 602. The beams 516 and 518 include respective base portions 524 and 526 spaced apart from one another. The base portions 524, 526 are bent inward toward one another at corners 528, 530. The beams 516 and 518 extend upward at angles toward one another. The beam 517 includes a base portion 534 that adjoins the base portions 524, 526 and is aligned perpendicular to the base portions 524, 526. The base portion 534 is bent at corner 536 inward toward beams 516 and 518. The beam 517 extends upward at an angle toward the beams 516 and 518. Outer end 532 of the beam 517 bends outward and away from the outer ends 520 and 522. The outer end 532 may be separated from the outer ends 520 and 522 by a gap 604.

The body section 504 includes a bottom edge 538 that is formed with a contact blade 540, extending downward along the longitudinal axis 502. The contact blade 540 is of a generally rectangular shape and has a chamfered outer end 542. The contact blade 540 has a thickness 541, a width 543, and a length 545. The thickness 541 is substantially less than the width 543.

The bottom edge 538 of the body section 504 may also include a stopping blade 544. The stopping blade 544 is of the same general width and thickness as the contact blade 540, but is shorter in length. The stopping blade 544 includes a flat bottom surface 546. The contact blade 544 is configured to be inserted into a via in the PCB 1000, until the stopping blade 544 abuts against a surface of the PCB 1000.

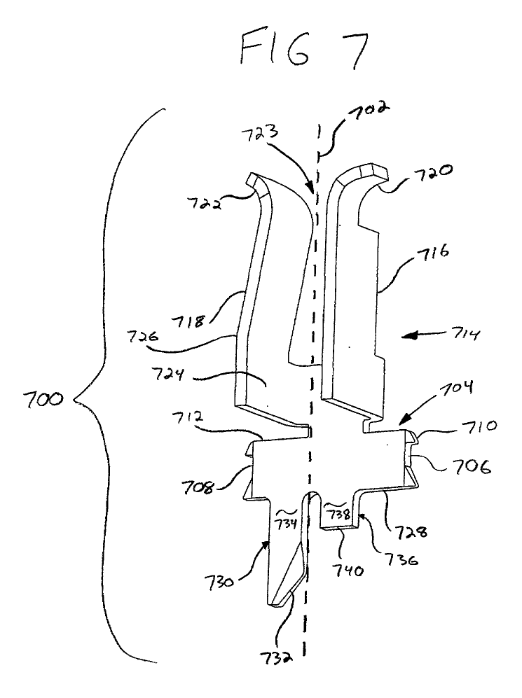

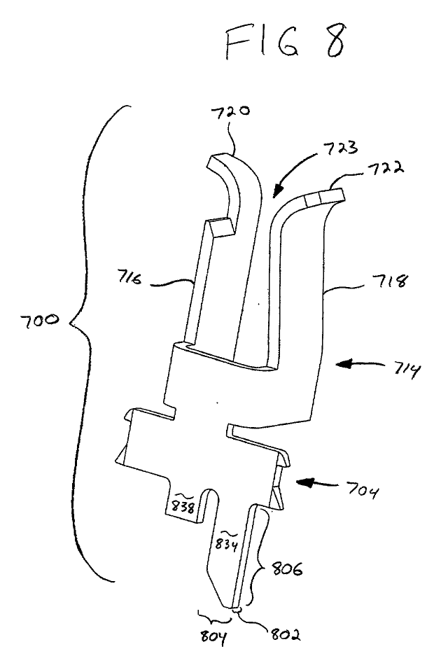

FIGS. 7 and 8 illustrate front and rear views of a ground contact 700 formed in accordance with an embodiment of the present invention. The ground contact 700 extends along a longitudinal axis 702 and includes a rectangular-shaped body section 704. The body section 704 includes two side edges 706, 708. Each side edge 706, 708 may include triangular retention bulges 710, extending outward from the body section 704. The retention bulges 710 retain the ground contact 700 in the connector housing 100 when installed. The body section 704 includes an upper edge 712 that is formed with a blade-receiving section 714, extending upward from the body section 704. The blade-receiving section 714 includes a pair of beams 716 and 718, extending upward in a direction parallel to the longitudinal axis 702 and perpendicular to the upper edge 712 of the body section 704. Outer ends 720 and 722 of the beams 716 and 718 bend away from one another. The outer ends 720 and 722 may be separated by a gap 723. The beam 718 includes a base portion 724 spaced apart from the beam 716 and bent at a corner 726 inward toward the beam 716. The beams 716 and 718 are configured to frictionally receive a blade contact on an electrical plug mated with the connector housing 100.

The body section 704 includes a bottom edge 728 that is formed with a contact blade 730, extending downward along the longitudinal axis 702. The contact blade 730 is of a generally rectangular shape and has a chamfered outer end 732. The contact blade 730 includes two planar surfaces 734, 834 (FIGS. 7 & 8) that are parallel to one another. The contact blade 730 has a thickness 802, a width, 804, and a length 806. The thickness 802 is substantially less than the width 804.

The bottom edge 728 of the body section 704 may also include a stopping blade 736. The stopping blade 736 is of the same general width and thickness as the contact blade 730, but is shorter in length. The stopping blade 736 includes two planar surfaces 738, 838 (FIGS. 7 & 8) that are parallel to one another and a flat bottom surface 740. The contact blade 730 is configured to be inserted into a via in the PCB 1000, until the stopping blade 736 abuts against a surface of the PCB 1000.

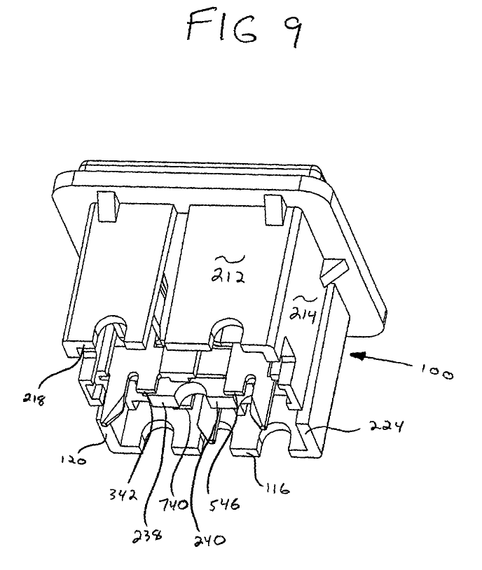

FIG. 9 illustrates a rear view of the connector housing 100 with the contacts 300, 500, 700 installed. The bottom edges 116, 120, 218, 224 of the sidewalls 112, 114, 212, 214, the bottom surfaces 238, 240 of the stabilizing projections 234, 236 and the bottom surfaces 342, 546, 740 of the stopping blades 338, 544, 736 are aligned in substantially the same plane.

FIG. 10 illustrates a PCB 1000 that includes a plurality of vias or holes 1002-1004 that are circular in shape. The holes 1002-1004 are configured to receive the contact blades 332, 540, 730 on the active contact 300, the neutral contact 500 and the ground contact 700, respectively. The holes include conductive tubular-shaped liners 1006 therein.

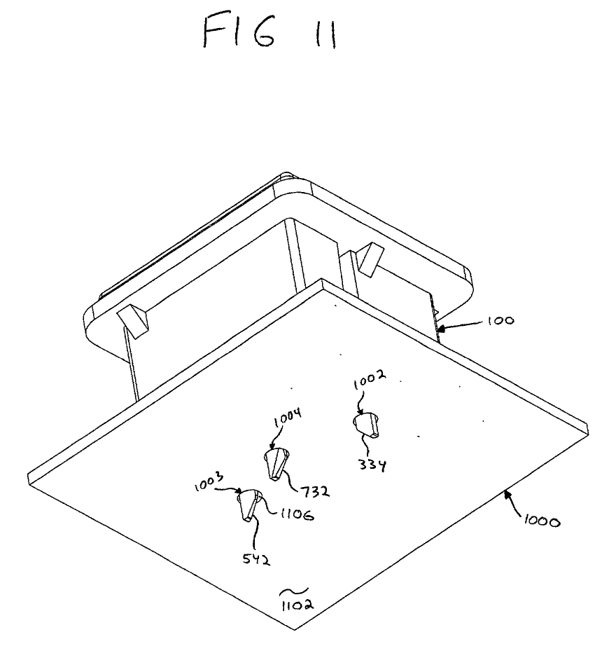

FIG. 11 illustrates a bottom view of the connector housing 100 with the active, neutral and ground contacts 300, 500, 700 mounted on the PCB 1000. The chamfered outer ends 334, 542 and 732 of the contact blades 332, 540, 730 protrude through the PCB 1000 beyond a bottom surface 1102 thereof. Because the holes 1002-1004 have circular shapes and the contact blades 332, 540, 730 have rectangular cross sections, the holes 1002-1004 include gaps 1106 therein between the conductive tubular-shaped liners 1006 and the contact blades 332, 540, 730. Optionally, the gaps 1106 can be filled with solder.

While certain embodiments of the present invention employ the connector housing having three contacts, other embodiments may include the connector housing having one contact, two contacts, or more than three contacts.

While certain embodiments of the present invention employ the outlet faces configured to receive 15 amperes and 20 amperes electrical plugs, the outlet faces are in no way limited to the outlet faces having configurations for receiving 15 amperes and 20 amperes electrical plugs.

While certain embodiments of the present invention employ the contacts having the stopping beam, other embodiments may include contacts without the stopping beam.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A convenience outlet mountable to a printed circuit board (PCB), comprising:
a connector housing having a face with a receptacle pattern in said face configured to be mated with an electrical plug;
a contact chamber defined within said connector housing, said contact chamber having an open end configured to abut against, and be mounted on, a PCB; and
a contact securely mounted in said contact chamber, said contact including a beam configured to electrically engage an electrical plug and a contact blade configured to be inserted into a via in a PCB.

2. The convenience outlet of claim 1, wherein said contact blade includes opposed planar side surfaces and has a width slightly less than a diameter of a circular via into which said contact blade is configured to be inserted.

3. The convenience outlet of claim 1, wherein said contact blade is rectangularly shaped with a width and thickness, said width being substantially greater than said thickness.

4. The convenience outlet of claim 1, wherein said contact blade includes opposed planar side surfaces that are separated by a thickness that is substantially smaller than a diameter of a circular via into which said contact blade is configured to be inserted.

5. The convenience outlet of claim 1, wherein said contact blade includes a chamfered outer end.

6. The convenience outlet of claim 1, wherein said contact is stamped and formed from a single piece of material.

7. The convenience outlet of claim 1, wherein said contact includes at least two beams configured to slidingly receive therebetween a mating contact of an electrical plug.

8. The convenience outlet of claim 1, further comprising at least two contacts securely mounted in said contact chamber, each of said at least two contacts including a corresponding contact blade configured to be inserted into a corresponding via in a PCB.

9. The convenience outlet of claim 1, wherein said contact blade and said beam are integrally formed with one another.

10. The convenience outlet of claim 1, further comprising a stopping blade adjacent to said contact blade, said stopping blade being configured to abut against a surface of a PCB when said contact blade is inserted into a via in a PCB.

11. The convenience outlet of claim 1, wherein said connector housing includes sidewalls surrounding said contact chamber, said sidewalls including heat dissipation openings therein.

12. The convenience outlet of claim 1, further comprising an active contact, a neutral contact and a ground contact, each of said contacts securely mounted in said contact chamber, each of said contacts including a beam configured to electrically engage an electrical plug and a contact blade configured to be inserted into a via in a PCB.

13. A PCB outlet assembly, comprising:
a printed circuit board (PCB) having a via therein, said via having a circular cross-section;
a connector housing having a face with a receptacle pattern in said face configured to be mated with an electrical plug;
a contact chamber defined within said connector housing, said contact chamber having an open end abutting against, and mounted on, said PCB; and
a contact securely mounted in said contact chamber, said contact including a beam configured to electrically engage an electrical plug and a contact blade residing in said via.

14. The PCB outlet assembly of claim 13, wherein said contact blade includes opposed planar side surfaces and has a width slightly less than a diameter of said via.

15. The PCB outlet assembly of claim 13, wherein said contact blade is rectangularly shaped and has a width and thickness, said width being substantially greater than said thickness.

16. The PCB outlet assembly of claim 13, wherein said contact blade includes opposed planar side surfaces that are separated by a thickness that is substantially smaller than a diameter of said circular cross section of said via.

17. The PCB outlet assembly of claim 13, wherein said contact includes at least two beams configured to slidingly receive therebetween a mating contact of an electrical plug.

18. The PCB outlet assembly of claim 13, further comprising at least two contacts securely mounted in said contact chamber, each of said at least two contacts including a corresponding contact blade residing in a corresponding via.

19. The PCB outlet assembly of claim 13, wherein said contact blade and said beam are integrally formed with one another.

20. The PCB outlet assembly of claim 13, further comprising a stopping blade abutting against a surface of said PCB.

21. The PCB outlet assembly of claim 13, wherein said contact blade is soldered to said via.
